(19) United States
(12) Patent Application Publication
(10) Pub. No.: US 2022/0311812 A1
(43) Pub. Date: Sep. 29, 2022

(54) METHOD AND SYSTEM FOR INTEGRATING VIDEO CONTENT IN A VIDEO CONFERENCE SESSION

(71) Applicant: VONAGE BUSINESS INC., Atlanta, GA (US)

(72) Inventors: Kfir Arie Eichenblat, Tel Aviv (IL); Ofer Edmond Sisso, Ashdod (IL); Ronny Orot, Petah Tikva (IL); Shay Yzhakov, Tel Aviv (IL)

(21) Appl. No.: 17/213,574

(22) Filed: Mar. 26, 2021

(51) Int. Cl. H04L 29/06; H04L 12/18; H04N 7/15

(52) U.S. Cl. CPC H04L 65/403; H04L 65/1089; H04L 12/1831; H04N 7/152; H04L 65/4015; H04L 65/4084; H04L 65/608

(57) ABSTRACT

Methods and system for integrating video content in a video conference session are provided herein. In some embodiments, the system comprises a plurality of user devices corresponding to a presenter attendee and a plurality of non-presenter attendees of the video conference, where each of the plurality of user devices comprising: a video conferencing application, comprising: a first interface for receiving connection information to the video content as selected by the presenter attendee; a second interface for embedding and displaying the video content on each of the plurality of user devices, wherein the video content is streamed directly from the content provider to each of the plurality of user devices; and a video conference server for relaying state changes of the content video content as the video content is streamed to the plurality of non-presenter user devices.

### BACKGROUND

### Field

Embodiments of the present invention generally relate video conferencing, and more specifically to a method and system for integrating video content in a video conference session.

### Description of the Related Art

Oftentimes during a video or conference call between two or more attendees, a conference attendee may wish to share a video, for example, third party video content with the other conference attendees. Typically, the host conference attendee plays the third party video content onto his or her screen, and then shares their computer screen with the other attendees in the video conference.

Unfortunately, video display via screen sharing leads to a poor viewer experience. First, the quality of both the video and audio streams that are provided to attendees viewing the media is poor in most scenarios and is limited by the connectivity of the user who is sharing their screen. Second, when sharing a screen, media servers of the video conferencing application are responsible for routing the streams from the user who is sharing their screen to the rest of the attendees. The user who is sharing the video controls the volume, captions, and other audio of the media content without enabling other attendees any control over the audio. In addition, web browsers do not allow apps to access system audio, meaning users who participate in conferences via their browser cannot utilize screen-sharing to present media that contains audio.

Therefore, there is a need in the art for integrating video content in a video conference session.

### SUMMARY

Methods and systems for integrating video content in a video conference session are provided herein. In some embodiments, methods for integrating video content in a video conference session may comprise receiving, on a first user device of a plurality of user devices in a video conference session, a link to third-party video content; and communicating the link to the plurality of user devices in the video conference session, wherein communicating the link causes each of the plurality of user devices to embed, using a third party iFrame application programming interface (API), the video content on each user device of the plurality of user devices locally.

A system for integrating video content in a video conference session is further provided herein. In some embodiments, a system for integrating video content in a video conference session, the system comprises a third-party video content provider; a plurality of user devices corresponding to a presenter attendee and a plurality of non-presenter attendees of the video conference session, where each of the plurality of user devices comprising: a video conferencing application, comprising: a first interface for receiving connection information to the video content as selected by the presenter attendee; a second interface for embedding and displaying the video content on each of the plurality of user devices, wherein the video content is streamed directly from the content provider to each of the plurality of user devices; and a video conference server for relaying state changes of the content video content as the video content is streamed to the plurality of non-presenter user devices.

Another method for integrating video content in a video conference session is further provided herein. In some embodiments, the method comprises receiving, on a first user device of a plurality of user devices in a video conference session, a link to video content, wherein the link is a universal resource location (URL) to third-party video content embedded by a presenter attendee on a second user device in the video conference session; and in response to receiving the link, embedding the video content into the video conference session on the first user device using a third party iFrame application programming interface (API).

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a communications environment to facilitate video conferencing via IP enhanced communications in accordance with exemplary embodiments of the present invention;

FIG. 2 is block diagram of a system for integrating video content in a video conference session, in accordance with exemplary embodiments of the present invention;

FIG. 3 is a flow diagram of a method for integrating video content into a video conference session, in accordance with exemplary embodiments of the present invention;

FIG. 4 depicts a flow diagram of a method for synchronizing playback of video content among attendees of a video conference session, according to one or more embodiments of the invention; and

FIG. 5 is an exemplary diagram of a computer system for integrating video content in a video conference session, in accordance with one or more embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to a method and system for integrating video content in a video conference session. One of a plurality of attendees selects media content to view within a conference session. The media content is selected from a third-party media content provider by a presenter attendee. A link to the media content is input into the video conferencing video sharing interface. A video conference server communicates the link to all attendees in the video conference, such that each attendee user device embeds the media content locally. Due to the fact that each attendee has the video embedded locally, each attendee may control the video on their own, including the ability to adjust the volume, quality, and closed captioning, as well as pause, resume, rewind, and fast forward. In addition, all non-presenter attendees have the ability to automatically keep their playback synchronized with the presenter attendee.

In the following description, the terms VOIP system, VOIP telephony system, IP system and IP communications system are all intended to refer to a system that connects callers and that delivers data, text and video communications using Internet protocol data communications.

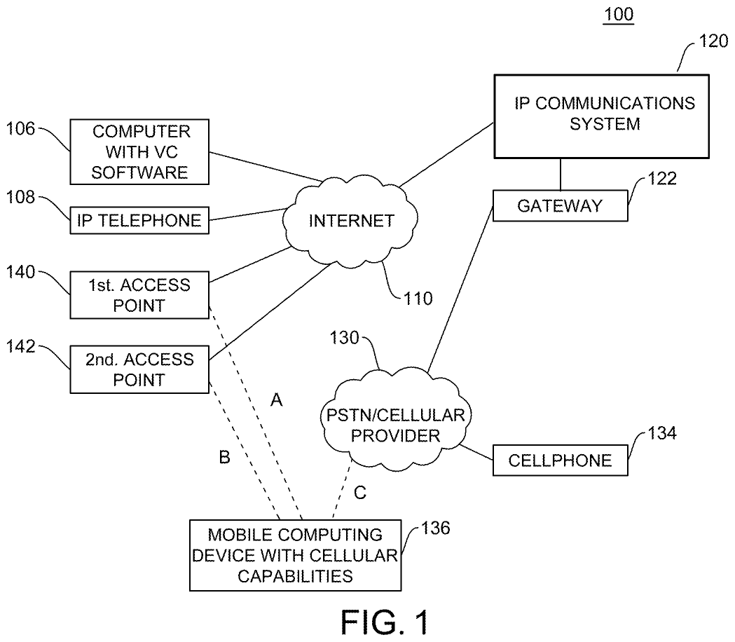

As illustrated in FIG. 1, a communications environment 100 is provided to facilitate video conferencing via an IP enhanced communications platform. An IP communications system 120 enables connection of communication sessions between its own customers and other attendees via data communications that pass over a data network 110. The data network 110 is commonly the Internet, although the IP communications system 120 may also make use of private data networks. The IP communications system 120 is connected to the Internet 110. In addition, the IP communications system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP communications system 120 and the PSTN 130 through the Internet 110 via a gateway maintained within the PSTN 130.

The gateway 122 allows users and devices that are connected to the PSTN 130 to connect with users and devices that are reachable through the IP communications system 120, and vice versa. In some instances, the gateway 122 would be a part of the IP communications system 120. In other instances, the gateway 122 could be maintained by a third attendee.

Customers of the IP communications system 120 could utilize a Unified Communications as a Service (UCaaS) instance (e.g., a client running on a computer 106) to place and receive IP based communication sessions, and to access other IP telephony systems (not shown). The UCaaS instance provides for a variety of communications methods including conversations across voice, SMS, team messaging, fax, social and video conferencing. One example of a UCaaS product that can provide this functionality is the Vonage Business Communications (VBC) product offered by Vonage Holdings Corp of Holmdel, N.J. In some instances, the UCaaS client could be assigned its own telephone number. In other instances, the UCaaS client could be associated with a telephone number that is also assigned to an IP telephone 108 that serves as a primary contact number (e.g., a business phone number or workstation).

Users of the IP communications system 120 are able to access the service from virtually any location where they can connect to the Internet 110. Thus, a customer could register with an IP communications system provider in the U.S., and that customer could then use an IP telephone 108 located in a country outside the U.S. to access the services. Likewise, the customer could also utilize a computer outside the U.S. that is running a UCaaS client to access the IP communications system 120.

A communication session attendee using a cellular telephone 134 could also place a call to an IP communications system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone and an IP telephone.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE iPhone®, that includes both cellular telephone capabilities and a wireless data transceiver that can establish a wireless data connection to a data network. Such a mobile computing device could run appropriate application software to conduct VOIP telephone calls via a wireless data connection. Thus, a mobile computing device, such as an APPLE iPhone®, or a comparable device running GOOGLE's ANDROID® operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE iPod Touch® and the iPad®. Such a device may act as a mobile telephony device once it is configured with appropriate application software.

FIG. 1 illustrates that a mobile computing device with cellular capabilities 136 is capable of establishing a first wireless data connection A with a first wireless access point 140, such as a WIFI or WI MAX router. The first wireless access point 140 is coupled to the Internet 110. Thus, the mobile computing device 136 can establish a VOIP telephone call with the IP communications system 120 via a path through the Internet 110 and the first wireless access point 140.

FIG. 1 also illustrates that the mobile computing device 136 can establish a second wireless data connection B with a second wireless access point 142 that is also coupled to the Internet 110. Further, the mobile computing device 136 can establish a third wireless data connection C via a data channel provided by a cellular service provider 130 using its cellular telephone capabilities. The mobile computing device 136 could also establish a VOIP telephone call with the IP communications system 120 via the second wireless connection B or the third wireless connection C.

Although not illustrated in FIG. 1, the mobile computing device 136 may be capable of establishing a wireless data connection to a data network, such as the Internet 110, via alternate means. For example, the mobile computing device 136 might link to some other type of wireless interface using an alternate communication protocol, such as the WI MAX standard.

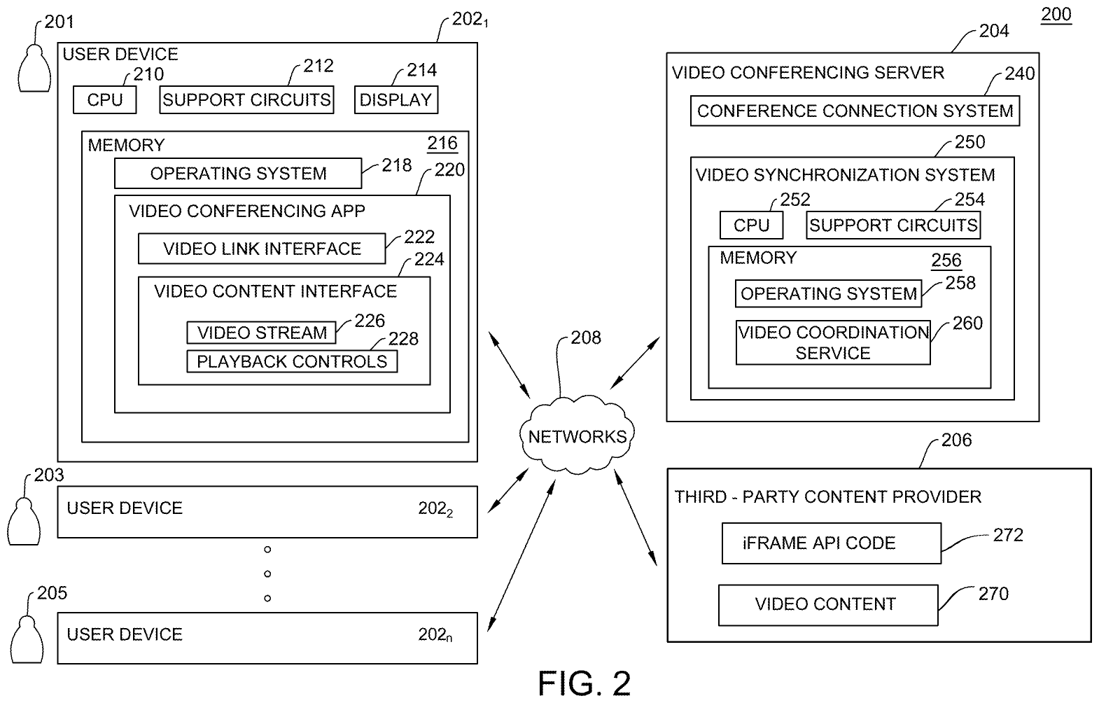

FIG. 2 is block diagram of a system 200 for integrating video content in a video conference session, in accordance with exemplary embodiments of the present invention. The system 200 comprises a plurality of user devices 202₁, 202₂, . . . 202ₙ (collectively referred to as user device 202), a video conference server 204, and a third-party content provider 206, communicatively coupled via networks 208. In some embodiments, the user device 202 may be a computer (such as computer 106 of FIG. 1) running a UCaaS software client capable of facilitating video conference sessions. The computer could be a laptop or desktop with the correct version UCaaS software installed and client account activated. In another example, the user device 202 may be a mobile computing device (e.g., 136_{A} of FIG. 1 with the correct version UCaaS software installed and client account activated associated with a user. The video conference server 204 may be a server maintained and operated by IP communications system 120 described above in FIG. 1. Although all user devices 202 have identical video conferencing functionality, for ease of explanation as used herein, the user of user device 202₁ is referred to as the presenter attendee 201, in that the presenter attendee selects the video content to be watched during the video conference session. All other users of user devices 202₂, . . . 202ₙ, are herein referred to as non-presenter attendees (e.g, 203, 205, et al).

The user device 202 may comprise a Central Processing Unit (CPU) 210, support circuits 212, a display 214, and a memory 216. The CPU 210 may comprise one or more commercially available microprocessors or microcontrollers that facilitate data processing and storage. The various support circuits 212 facilitate the operation of the CPU 210 and include one or more clock circuits, power supplies, cache, input/output device and circuits, and the like. The memory 216 comprises at least one of Read Only Memory (ROM), Random Access Memory (RAM), disk drive storage, optical storage, removable storage and/or the like. In some embodiments, the memory 216 comprises an operating system 218 and a UCaaS application having video conferencing capabilities or a stand-alone video conferencing app 220. The video conferencing app 220 includes a video link interface 222 and a video content interface 224. In some embodiments, the video content interface 224 is an embedded iFrame that includes a third-party video player. The video content interface 224 includes a video stream 226 from the third-party content provider 206 and playback controls 228.

The operating system 218 generally manages various computer resources (e.g., network resources, file processors, and/or the like). The operating system 218 is configured to execute operations on one or more hardware and/or software modules, such as Network Interface Cards (NICs), hard disks, virtualization layers, firewalls and/or the like. Examples of the operating system 218 may include, but are not limited to, various versions of LINUX, MAC OSX, BSD, UNIX, MICROSOFT WINDOWS, IOS, ANDROID and the like.

In some embodiments, the video conference server 204 includes a conference coordination system 240 and a video synchronization system 250. The conference coordination system 240 may be a separate entity that provides conference coordination services to the video conference server 204. Conference coordination services may include sending conference invitations, collecting attendee responses, gathering attendee information, coordinating conference call setup among attendee devices, monitoring signaling from attendee devices, and the like. The video synchronization system 250 provides video content coordination services to presenter attendees 201, and non-presenter attendees 203 and 205, each attendee accessing the video conference session via their corresponding user device 202₁, 202₂, and 202ₙ, respectively. The video synchronization system 250 comprises a Central Processing Unit (CPU) 252, support circuits 254, and memory 256. The CPU 252 may comprise one or more commercially available microprocessors or microcontrollers that facilitate data processing and storage. The various support circuits 254 facilitate the operation of the CPU 252 and include one or more clock circuits, power supplies, cache, input/output circuits, and the like. The memory 256 comprises at least one of Read Only Memory (ROM), Random Access Memory (RAM), disk drive storage, optical storage, removable storage and/or the like. In some embodiments, the memory 256 comprises an operating system 258, and a video coordination service 260.

The operating system 258 generally manages various computer resources (e.g., network resources, file processors, and/or the like). The operating system 258 is configured to execute operations on one or more hardware and/or software modules, such as Network Interface Cards (NICs), hard disks, virtualization layers, firewalls and/or the like. Examples of the operating system 258 may include, but are not limited to, LINUX, MAC OSX, BSD, UNIX, MICROSOFT WINDOWS, 10S, ANDROID and the like.

The third-party content provider 206 is a repository of media content 270. Examples of third-party content providers 206 include YouTube®, Dailymotion®, Vimeo®, Twitch®, Facebook® and the like that provide video content.

The networks 208 comprise one or more communication systems that connect computers by wire, cable, fiber optic and/or wireless link facilitated by various types of well-known network elements, such as hubs, switches, routers, and the like. The networks 208 may include an Internet Protocol (IP) network 110, a public switched telephone network (PSTN) 130, or other mobile communication networks listed above, and may employ various well-known protocols to communicate information amongst the network resources.

In some embodiments, the conference coordination system 240 establishes a video conference session between user devices 202. The presenter attendee 201 may search for third-party media content to play in the video conference. Presenter attendee 201 selects the media content 270 and inputs a link, for example, a universal resource location (URL) to the media content 270 into the video link interface 222. When the link is verified by the video conferencing app 220 as coming from the third-party content provider 206, a message is sent to the video coordination service 260 to provide the link to the user devices 202 of the non-presenter attendees. The link is received by the video conferencing app 220 of the other user devices 202 corresponding to the non-presenter attendees. Each user device 202 corresponding to the non-presenter attendees uses the third party iFrame API to embed the video locally on the user device 202. As such, each user device 202 has its own video stream 226 directly from the third-party media provider and its own playback controls 228. More specifically, the third party content provider 206 includes a “package” of code 272 that enables the functionality of media playback as an iFrame API. This code 272 is imported by the video conferencing app 220 so that it is capable of displaying the video content within the desired video conference session. In one example of the invention, the code 272 is imported into the video conferencing app 220 from the third-party media provider 206 upon launch of the app 220.

The presenter attendee 201 may pause, resume, rewind, or fast forward the video content using the playback controls 228 of the user device 202₁. When the presenter attendee 201 performs any playback adjustment, the third-party iFrame API triggers a callback to the video conferencing app 220 of the change in the playback state. The video conferencing app 220 communicates the state change to the video coordination service 260 on the video conference server 204, which in turn communicates the state change to each of the user devices 202₂, . . . 202ₙ. The user devices 202 corresponding to the non-presenter attendees use the third party iframe API to apply the change of the playback state to automatically adjust their playback to be in sync with the presenter attendee. In some embodiments, a message is displayed to the non-presenter attendees such that the non-presenter attendees may opt whether to have their playback adjusted to match that of the presenter attendee.

Due to the fact that each user device 202 is viewing its own video stream 226 of the media content, a non-presenter attendee may adjust various controls as part of their playback controls 228 without affecting the playback on the other user devices 202. For example, a non-presenter attendee 203 may adjust a volume of the video playback, add or remove closed captioning for the video, or even select a different video quality of the video stream 226. In addition to playback controls giving the non-presenter attendee the ability to pause, resume, rewind, or fast-forward the video content without affecting the playback of the other attendees, the non-presenter may select to synchronize with the presenter attendee. Optionally, the presenter attendee (when forwarding the link to the video content to be presented) may include instructions/coding that the non-presenters not have playback options but only non-playback functions such as volume, closed captioning, codec selection and the like. Such code may be optionally selected by the presenter or specifically part of the third party content providers code. In this way, the video conferencing app 220 can have its own playback controls developed and implemented. In some embodiments, a non-presenter attendee may select, using playback controls 228, an option to synchronize their video playback with that of the present attendee. When a presenter attendee broadcasts an update, each non-presenter attendee device receives a notification of the update and stores in memory the location of the video playback of the presenter attendee. When the presenter attendee broadcasts that their video is playing, each non-presenter attendee also saves a timestamp of the moment the non-attendee device received the update. When a non-presenter attendee chooses to synchronize with the presenter attendee, when the video on the presenter attendee device is paused, the location is updated on the non-presented attendee device based on the stored location of the video playback. When a non-presenter attendee chooses to synchronize with the presenter attendee, when the video on the presenter attendee device is playing, the location of the video is updated on the non-presenter attendee device based on the stored location, and the duration of time elapsed since the timestamp of when the playback update was received.

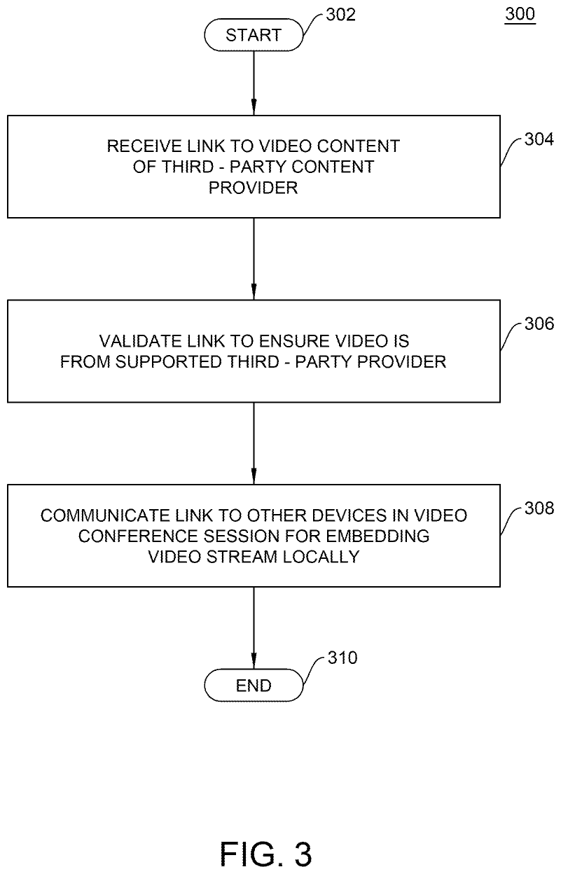

FIG. 3 is a flow diagram of a method 300 for integrating video content into a video conference session, according to one or more embodiments of the invention. The method 300 is initiated in response to a video selection, after a video conference session has begun. The method starts at step 302 and proceeds to step 304.

At step 304, a link to video content is received in a user interface of a video conferencing application. The user device where the link is received is referred to as the user device of the presenter attendee. All other parties in the video conference session are referred to as non-presenter attendees. The link is to video content selected from a third-party media provider. In some embodiments, the link is in the form of a URL.

At step 306, the link is validated to ensure it is from a supported third-party video provider. Links to videos from non-supported video providers are discarded.

At step 308, after the link is validated, the link is communicated to the other user devices taking part in the video conference. The link is transmitted to a server that coordinates the video conference session. The server in turn transmits the link to the other user devices corresponding to all non-presenter attendees.

At step 310, upon receipt of the link, the user devices corresponding to the non-presenter attendees use a third-party iFrame API to embed the video locally on the user device. As such, each user device streams the video directly from the third-party provider while participating in the video conference. The method 300 ends at step 310.

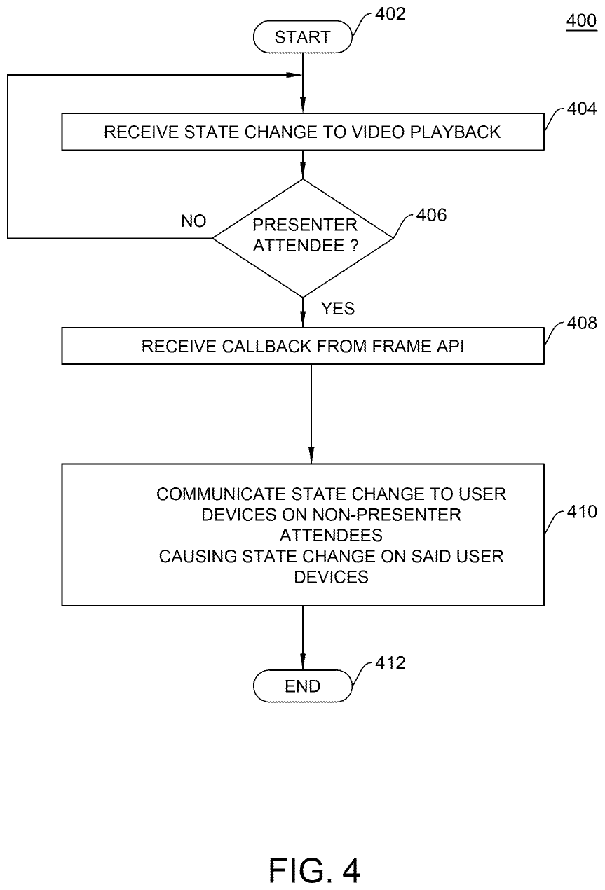

FIG. 4 depicts a flow diagram of a method 400 for synchronizing playback of video content among attendees of a video conference session, according to one or more embodiments of the invention. The method 400 starts at step 402 and proceeds to step 404.

At step 404, a state change of video content playback is received. An attendee uses playback controls to change a state of the video playback on the user device corresponding to the attendee. The attendee may stop play, resume play, rewind the video, or fast-forward the video.

At step 406, the method determines whether the user device corresponds to the presenter attendee (i.e., the attendee who initially selected the video that is integrated in the video conference session). If the user device does not correspond with the presenter attendee, no action is taken. A non-presenter attendee may use any playback controls without affecting playback on the user devices of the other attendees of the video conference session. Only the presenter attendee has control over the video playback for the remaining attendees. If the user is not the presenter attendee, the method proceeds to step 404 and iterates until it is determined that playback controls changed the state on the user device associated with the presenter attendee. However, if at step 406, it is determined that the state change is from the user device corresponding to the presenter attendee, then at step 408, the iFrame API triggers a callback to the video conferencing app indicating the state change of the video playback.

At step 410, the video conferencing app communications the state change to all non-presenter attendee user devices. The video conferencing app transmits the state change to the video conference server, which in turn passes the information to each of the user devices of the non-presenter attendees. Communicating the state change to the non-presenter attendee devices causes each device to, using the third-party iFrame API, apply the change of the playback state locally on the user device.

The method 400 ends at step 412.

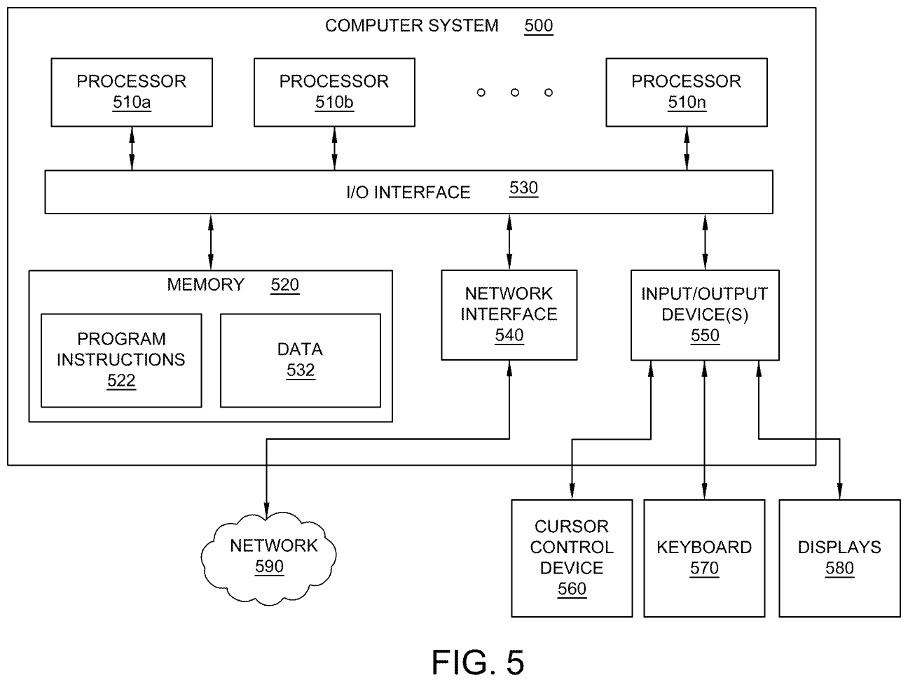

FIG. 5 depicts a computer system that can be used to implement the methods of FIG. 3 and FIG. 4 in various embodiments of the present invention. Various embodiments of a method and system for integrating third-party video content into a video conference session, as described herein, may be executed on one or more computer systems, which may interact with various other devices. One such computer system is computer system 500 illustrated by FIG. 5, which may in various embodiments implement any of the elements or functionality illustrated in FIGS. 1-4. In various embodiments, computer system 500 may be configured to implement methods described above. The computer system 500 may be used to implement any other system, device, element, functionality or method of the above-described embodiments. In the illustrated embodiments, computer system 500 may be configured to implement methods 300 and 400, as processor-executable executable program instructions 522 (e.g., program instructions executable by processor(s) 510) in various embodiments.

In the illustrated embodiment, computer system 500 includes one or more processors 510 coupled to a system memory 520 via an input/output (I/O) interface 530. Computer system 500 further includes a network interface 540 coupled to I/O interface 530, and one or more input/output devices 550, such as cursor control device 560, keyboard 570, and display(s) 580. In various embodiments, any of components may be utilized by the system to receive user input described above. In various embodiments, a user interface (e.g., user interface 530) may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510 may be any suitable processor capable of executing instructions. For example, in various embodiments processors 510 may be general-purpose or embedded processors implementing any of a variety of instruction set architectures (ISAs), such as the x96, PowerPC, SPARC, or MIPS ISAs, or any other suitable ISA. In multiprocessor systems, each of processors 510 may commonly, but not necessarily, implement the same ISA.

System memory 520 may be configured to store program instructions 522 and/or data 532 accessible by processor 510. In various embodiments, system memory 520 may be implemented using any suitable memory technology, such as static random access memory (SRAM), synchronous dynamic RAM (SDRAM), nonvolatile/flash-type memory, persistent storage (magnetic or solid state), or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510 , system memory 520, and any peripheral devices in the system, including network interface 540 or other peripheral interfaces, such as input/output devices 550, In some embodiments, I/O interface 530 may perform any necessary protocol, timing or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 550 may, in some embodiments, include one or more display terminals, keyboards, keypads, touch pads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

In some embodiments, the illustrated computer system may implement any of the methods described above, such as the method illustrated by the flowchart of FIG. 3 and FIG. 4. In other embodiments, different elements and data may be included.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A system for integrating third-party video content into a video conference session of a plurality of a presenter attendee and non-presenter attendees comprising:
a plurality of user devices corresponding to a presenter attendee and a plurality of non-presenter attendees of the video conference session, where each of the plurality of user devices comprising:
a) at least one processor;
b) a video conferencing application, comprising:
i) a first interface for receiving connection information to the third-party video content as selected by the presenter attendee;
ii) a second interface for embedding and displaying the third-party video content on each of the plurality of user devices, wherein the video content is streamed directly from a third-party content provider to each of the plurality of user devices; and
a video conference server for relaying state changes of the third-party video content as the video content is streamed to the plurality of non-presenter user devices.

2. The system of claim 1, wherein the video conference server relays state changes of the third-party video content when a state change is made on the user device corresponding to the presenter attendee.

3. The system of claim 1, wherein the second interface is a third-party iFrame comprising an embedded third-party video player.

4. The system of claim 1, wherein managing the state comprises communicating the connection information of the third-party video content to the plurality of user devices corresponding to the non-presenter attendees.

5. The system of claim 1, wherein managing state changes comprises communicating playback control information from the presenter attendee to the plurality of user devices corresponding to the non-presenter attendees.

6. The system of claim 5, wherein the playback control information includes one selected from a list of a pause function, a resume function, a rewind function, and a fast forward function.

7. The system of claim 1, wherein playback control information on a user device corresponding to a non-presenter attendee changes the playback for the user device corresponding to the non-presenter attendee only.

8. The system of claim 1, wherein the video conferencing application further comprises audio control capabilities from a user device corresponding to a non-presenter attendee, wherein audio control information includes adjusting a volume of the video content and/or adjusting closed captioning, wherein audio control changes audio settings for the user device corresponding to the non-presenter attendee only.

9. The system of claim 1, wherein a live streaming quality of the video content is selectable to be changed locally on each user device of the plurality of user devices.

10. The system of claim 1, wherein the video conference session attendees corresponding to the plurality of user devices are displayed alongside the video content.

11. A computer-implemented method of embedding third-party video content in a video conference session on a user device, comprising:
receiving, on a first user device of a plurality of user devices in a video conference session, a link to third-party video content; and
communicating the link to the plurality of user devices in the video conference session, wherein communicating the link causes each of the plurality of user devices to embed, using a third party iFrame application programming interface (API), the video content on each user device of the plurality of user devices locally.

12. The method of claim 11, further comprising:
receiving a state change of the video playback on the first user device;
triggering, by the third-party iFrame API on the first user device, a call to communicate the change of playback state to the plurality of user devices; and
communicating the change of playback state to the plurality of user devices, wherein communicating the change of playback state causes each of the plurality of user devices to apply, using the third-party iFrame API, the change of the playback state locally.

13. The method of claim 11, wherein the link is a universal resource location (URL) to a third-party video content provider.

14. The method of claim 11, further comprising validating the link to the third-party content to ensure the link is from a supported third-party video content provider.

15. The method of claim 11, wherein the communication of the state change comprises sending the state change to a video conference server that is coordinating the video conference session.

16. A method of embedding third-party video content in a video conference session on a user device of a non-presenter attendee, comprising:
receiving, on a first user device of a plurality of user devices in a video conference session, a link to video content, wherein the link is a universal resource location (URL) to third-party video content for presentation by a presenter attendee to one or more second user devices in the video conference session; and
in response to receiving the link, embedding the video content into the video conference session on the plurality of user devices using a third party iFrame application programming interface (API).

17. The method of claim 16, further comprising:
receiving a notification of a state change of the video playback on the second user device; and
in response to receiving the notification of the state change, using the third-party iFrame API to apply the change of the playback state locally on the first user device.

18. The method of claim 16, further comprising:
receiving a state change of the video playback; and
in response to receiving the state change, using the third-party iFrame API to apply the change of the playback state locally.

19. The method of claim 18, wherein the received the state change is received from a video conference server that is coordinating the video conference session.

20. The method of claim 16, further comprising receiving, on the first user device, audio control information of the video playback, wherein the audio control information comprising adjusting a volume of the video playback and/or changing closed captioning settings for the video playback, wherein audio adjustment is applied locally on the first user device without altering the audio of the remaining plurality of user devices in the video conference session.

21. The method of claim 16, further comprising receiving, on the first user device, a change to a streaming quality of the video content, wherein the change to the streaming is applied locally to the first user device without altering the streaming quality of the video content of the remaining plurality of user devices in the video conference session.
